(19) United States
(12) Patent Application Publication
(10) Pub. No.: US 2021/0214239 A1
(43) Pub. Date: Jul. 15, 2021

(54) PROCESS FOR PURIFYING A LITHIUM BIS(FLUOROSULFONYL)IMIDE SALT

(71) Applicant: ARKEMA FRANCE, Colombes (FR)

(72) Inventors: Philippe LEDUC, Pierre-Benite (FR); Grégory SCHMIDT, Pierre-Benite (FR); Dominique DEUR-BERT, Pierre-Benite (FR)

(73) Assignee: ARKEMA FRANCE, Colombes (FR)

(21) Appl. No.: 17/058,730

(22) PCT Filed: May 28, 2019
(86) PCT No.: PCT/FR2019/051250

§ 371 Date: Nov. 25, 2020

(30) Foreign Application Priority Data
Jun. 1, 2018 (FR) 1854766

(51) Int. Cl. C01D 15/00; B01D 11/04

(52) U.S. Cl. CPC C01D 15/00; B01D 11/0492

(57) ABSTRACT

The invention relates to a process for purifying a lithium bis(fluorosulfonyl)imide salt. The present invention relates to a process for purifying a lithium bis(fluorosulfonyl)imide salt in a solution in at least one solvent S1, said process comprising at least one purification step carried out in:—a piece of silicon carbide-based or fluorinated polymer-based equipment; or—a piece of metal or glass equipment comprising an inner surface, said inner surface, which can come into contact with the lithium bis(fluorosulfonyl)imide salt, being covered with a polymer coating or with a silicon carbide coating.

### FIELD OF THE INVENTION

The present invention relates to a process for purifying a lithium bis(fluorosulfonyl)imide salt.

### TECHNICAL BACKGROUND

The development of higher-power batteries is required for the Li-ion battery market. This is done by increasing the nominal voltage of Li-ion batteries. To achieve the targeted voltages, high-purity electrolytes are required. By virtue of their very low basicity, anions of sulfonylimide type are increasingly used in the field of energy storage in the form of inorganic salts in batteries, or of organic salts in supercapacitors or in the field of ionic liquids.

In the specific field of Li-ion batteries, the salt that is currently the most widely used is LiPF₆. This salt has many drawbacks, such as limited thermal stability, sensitivity to hydrolysis and thus poorer safety of the battery. Recently, novel salts bearing the fluorosulfonyl group FSO₂⁻ have been studied and have demonstrated many advantages such as better ion conductivity and resistance to hydrolysis. One of these salts, LiFSI, has shown highly advantageous properties which make it a good candidate for replacing LiPF₆.

The identification and quantification of impurities in salts and/or electrolytes and the understanding of their impacts on battery performance have become paramount. For example, on account of their interference with electrochemical reactions, impurities bearing a labile proton lead to reduced overall performance qualities and stability for Li-ion batteries. The application of Li-ion batteries makes it necessary to have high-purity products (minimum amount of impurities).

The existing processes for purifying LiFSI notably comprise steps performed in equipment made of glass, enamelled steel, carbon steel, etc. Now, certain metal ions, for instance sodium ions, may elute from the materials of said equipment and thus contaminate the LiFSI. The presence of metal ions in the LiFSI in excessive amount may disrupt the functioning and performance of the battery, for example on account of the deposition of said metal ions on the battery electrodes.

Thus, there is a need for a novel process for purifying a lithium salt of bis(fluorosulfonyl)imide leading to a high-purity LiFSI with a reduced content of metal ions.

### DESCRIPTION OF THE INVENTION

The present invention relates to a process for purifying a lithium bis(fluorosulfonyl)imide salt in solution in at least one solvent S1, said process comprising at least one purification step performed in:
equipment based on silicon carbide or based on a fluoropolymer; or
equipment made of steel, preferably of carbon steel, comprising an inner surface, said inner surface liable to be in contact with the lithium salt of bis(fluorosulfonyl)imide being covered with a polymeric coating or with a silicon carbide coating.

In the context of the invention, the terms “lithium bis(fluorosulfonyl)imide salt”, “lithium bis(sulfonyl)imide”, “LiFSI”, “LiN(FSO₂)₂”, “lithium bis(sulfonyl)imide” and “lithium bis(fluorosulfonyl)imide” are used equivalently.

Preferably, the purification step is a step in which the lithium salt of bis(fluorosulfonyl)imide is in contact with water.

The purification step may be a liquid-liquid extraction step, a concentration step, a decantation step, etc.

The equipment may be a reactor, an evaporator, a mixer-decanter, a liquid-liquid extraction column, a decanter or an exchanger.

When the purification step is a liquid-liquid extraction, the equipment may be a liquid-liquid extraction column or a mixer-decanter.

When the purification step is a concentration, the equipment may be an evaporator or an exchanger.

When the purification step is a decantation, the equipment may be a decanter.

Preferably, the solvent S1 is an organic solvent.

According to one embodiment, the organic solvent S1 is chosen from the group constituted of esters, nitriles, ethers, and mixtures thereof. Preferably, the solvent S1 is chosen from ethyl acetate, butyl acetate, tetrahydrofuran, acetonitrile and diethyl ether, and mixtures thereof, the organic solvent S1 preferentially being butyl acetate.

According to one embodiment, the purification process according to the invention comprises the following steps:

a) liquid-liquid extraction of the lithium salt of bis(fluorosulfonyl)imide with deionized water, and recovery of an aqueous solution of said lithium salt of bis(fluorosulfonyl)imide;

a′) optional concentration of said aqueous solution of said salt;

b) liquid-liquid extraction of the lithium salt of bis(fluorosulfonyl)imide from said aqueous solution with at least one organic solvent S2;

c) concentration of the lithium salt of bis(fluorosulfonyl)imide by evaporation of said organic solvent S2;

d) optional crystallization of the lithium salt of bis(fluorosulfonyl)imide;

at least one of the steps a), a′), b) or c) being performed in:
equipment based on silicon carbide or based on a fluoropolymer; or
equipment made of steel, preferably of carbon steel, comprising an inner surface, said inner surface liable to be in contact with the lithium salt of bis(fluorosulfonyl)imide being covered with a polymeric coating or with a silicon carbide coating.

In the context of the invention, the terms “demineralized water” and “deionized water” are used equivalently.

The polymeric coating may be a coating comprising at least one of the following polymers: polyolefins, for instance polyethylene, fluoropolymers, for instance PVDF (polyvinylidene fluoride), PTFE (polytetrafluoroethylene), PFAs (copolymers of C₂F₄ and of perfluorinated vinyl ether), FEPs (copolymers of tetrafluoroethylene and of perfluoropropene, for instance the copolymer of C₂F₄ and of C₃F₆), ETFE (copolymer of tetrafluoroethylene and of ethylene), and FKM (copolymer of hexafluoropropylene and of difluoroethylene).

Preferably, the polymeric coating comprises at least one fluoropolymer, and in particular PFA, PTFE or PVDF.

The equipment based on silicon carbide is preferably equipment made of bulk silicon carbide.

The equipment based on a fluoropolymer is preferably equipment made of bulk fluoropolymer.

The fluoropolymer is advantageously chosen from PVDF (polyvinylidene fluoride), PTFE (polytetrafluoroethylene), PFAs (copolymers of C₂F₄ and of perfluorinated vinyl ether) and ETFE (copolymer of tetrafluoroethylene and of ethylene).

The fluoropolymer of the equipment is advantageously chosen from PVDF, PFAs and ETFE.

Preferably, the process according to the invention is such that:
step a) is performed in equipment as defined above; and/or
step a′) is performed in equipment as defined above; and/or
step b) is performed in equipment as defined above; and/or
step c) is performed in equipment as defined above.

According to one embodiment, the mass content of LiFSI in the at least one solvent S1 is between 5% and 55%, preferably between 5% and 65%, preferentially between 10% and 60%, advantageously between 10% and 55%, for example between 10% and 50%, in particular between 15% and 45% and preferentially between 25% and 40% by mass, relative to the total mass of the solution.

### Step a)

Step a) may be performed in equipment chosen from an extraction column, a mixer-decanter, and mixtures thereof.

According to one embodiment, the liquid-liquid extraction step a) is performed in:
an extraction column or a mixer-decanter, based on silicon carbide or based on a fluoropolymer preferably as defined previously; or
an extraction column or a mixer-decanter, made of steel, preferably made of carbon steel, said extraction column or said mixer-decanter comprising an inner surface, said inner surface liable to be in contact with the lithium salt of bis(fluorosulfonyl)imide being covered with a polymeric coating preferably as defined previously or with a silicon carbide coating.

Preferably, the liquid-liquid extraction step a) is performed in:
an extraction column or a mixer-decanter based on a fluoropolymer, for instance PVDF (polyvinylidene fluoride), or PFAs (copolymers of C₂F₄ and of perfluorinated vinyl ether); or
an extraction column or a mixer-decanter, made of steel, preferably made of carbon steel, said extraction column or said mixer-decanter comprising an inner surface, said inner surface liable to be in contact with the lithium salt of bis(fluorosulfonyl)imide being covered with a polymeric coating preferably as defined previously.

Mixer-decanters are well known to those skilled in the art. This equipment is typically a single machine comprising a mixing chamber and a decantation chamber, the mixing chamber comprising a stirring head advantageously enabling mixing of the two liquid phases. In the decantation chamber, the separation of the phases takes place by gravity.

The decantation chamber may be fed from the mixing chamber by overspill, from the bottom of the mixing chamber, or via a perforated wall between the mixing chamber and the decantation chamber.

The extraction column may comprise:
at least one packing, for instance random packing and/or structured packing. This packing may be Raschig rings, Pall rings, Saddle rings, Berl saddles, Intalox saddles, or beads;

and/or
trays, for instance perforated trays, fixed valve trays, movable valve trays, bubble trays or combinations thereof;

and/or
devices for atomizing one phase in another, for instance nozzles;
   said packing(s), tray(s) or atomization device(s) preferably being made of a polymeric material, the polymeric material possibly comprising at least one polymer chosen from polyolefins, for instance polyethylene, fluoropolymers, for instance PVDF (polyvinylidene fluoride), PTFE (polytetrafluoroethylene), PFAs (copolymers of C₂F₄ and of perfluorinated vinyl ether), FEPs (copolymers of tetrafluoroethylene and of perfluoropropene, for instance the copolymer of C₂F₄ and of C₃F₆), ETFE (copolymer of tetrafluoroethylene and of ethylene), and FKM (copolymer of hexafluoropropylene and of difluoroethylene).

The extraction column may also comprise chicanes integrally fastened to the side walls of said column. The chicanes advantageously make it possible to limit the phenomenon of axial mixing.

In the context of the invention, the term “packing” refers to a solid structure that is capable of increasing the area of contact between the two liquids placed in contact.

The height and/or diameter of the extraction column typically depend(s) on the nature of the liquids to be separated.

The extraction column may be a static or stirred column. Preferably, the extraction column is stirred, preferentially mechanically. It comprises, for example, one or more stirring heads attached to an axial rotating shaft. Among the stirring heads, examples that may be mentioned include turbomixers (for example Rushton straight-blade turbomixers or curved-blade turbomixers), impellers (for example profiled-blade impellers), disks, and mixtures thereof. Stirring advantageously allows the formation of fine droplets to disperse one liquid phase in the other, and thus to increase the interfacial area of exchange. Preferably, the stirring speed is chosen so as to maximize the interfacial area of exchange.

Preferably, the stirring head(s) are made of a steel material, preferably of carbon steel, comprising an outer surface, said outer surface liable to be in contact with the lithium salt of bis(fluorosulfonyl)imide being covered with a polymeric coating preferably as defined previously, or with a silicon carbide coating.

According to the invention, step a) of the process may be repeated at least once, preferably repeated from 1 to 10 times, preferentially from 1 to 4 times. When step a) is repeated, it may be performed in several mixer-decanters in series.

Step a) may be performed continuously or batchwise, preferably continuously.

According to one embodiment, step a) of the purification process according to the invention comprises the addition of deionized water to the solution of LiFSI in the abovementioned organic solvent S1, for example obtained during previous synthetic steps, to allow the dissolution of said salt and the extraction of said salt into water (aqueous phase).

In the particular case of a batchwise process, and during the repetition of step a), an amount of deionized water corresponding to at least half of the mass of the initial solution may be added in a first extraction, followed by an amount greater than or equal to about a third of the mass of the initial solution during the second extraction, and then an amount greater than or equal to about a quarter of the mass of the initial solution during the third extraction.

According to one embodiment, step a) is such that the mass of deionized water is greater than or equal to a third, preferably greater than or equal to half, of the mass of the initial solution of LiFSI in the organic solvent S1 (in the case of a single extraction, or for the first extraction only if step a) is repeated at least once).

The process according to the invention may comprise the addition of a volume of deionized water in step a) of greater than or equal to a third, preferably greater than or equal to half of the volume of solvent S1 of the initial solution.

In the event of multiple extractions (repetition of step a)), the extracted aqueous phases are pooled to form a single aqueous solution.

Step a) advantageously allows the production of an aqueous phase and an organic phase, which are separated. Step b) is thus advantageously performed on the aqueous solution extracted in step a) (single aqueous phase or pooled aqueous phases in the case of repetition of step a)).

Preferably, in the process according to the invention, the organic phase(s) separated from the aqueous solution extracted in step a) (comprising the organic solvent S1 and LiFSI) are not reintroduced into the subsequent steps b) to d) of the process; in particular, they are not subsequently pooled with the organic phases extracted during step b) (comprising the organic solvent S2).

On conclusion of step a), an aqueous solution of LiFSI is advantageously obtained. Preferably, the mass content of LiFSI in the aqueous solution is between 5% and 35%, preferably between 10% and 25%, relative to the total mass of the solution.

### Step a′)

The process according to the invention may comprise a concentration step a′) between step a) and step b), preferably to obtain an aqueous solution of LiFSI comprising a mass content of LiFSI of between 20% and 80%, in particular between 25% and 80%, preferably between 25% and 70% and advantageously between 30% and 65% relative to the total mass of the solution.

The concentration step may be performed under reduced pressure, for example at a pressure below 50 mbar abs (preferably below 30 mbar abs), and/or at a temperature of between 25° C. and 60° C., preferably between 25° C. and 50° C., preferentially between 25° C. and 40° C.

Step a′) may be performed in at least one item of equipment chosen from an evaporator, an exchanger, and mixtures thereof.

According to one embodiment, the concentration step a′) is performed in:
an exchanger or an evaporator, based on silicon carbide or based on a fluoropolymer preferably as defined previously; or
an exchanger or evaporator, made of steel, preferably made of carbon steel, said exchanger or evaporator comprising an inner surface, said inner surface liable to be in contact with the lithium salt of bis(fluorosulfonyl)imide being covered with a polymeric coating preferably as defined previously or with a silicon carbide coating. Preferably, step a′) is performed in:
an exchanger or evaporator, based on silicon carbide; or
an exchanger or evaporator, made of steel, preferably made of carbon steel, said exchanger or evaporator comprising an inner surface, said inner surface liable to be in contact with the lithium salt of bis(fluorosulfonyl)imide being covered with a silicon carbide coating.

Preferably, the purification process according to the invention comprises step a′). After concentration a′) of the aqueous solution obtained on conclusion of step a), a concentrated aqueous solution of LiFSI is obtained.

### Step b)

Step b) may be performed on the aqueous solution obtained on conclusion of step a) or of the concentration step a′) or of another optional intermediate step.

Step b) may be performed in equipment chosen from an extraction column, a mixer-decanter, and mixtures thereof.

According to one embodiment, the liquid-liquid extraction step b) is performed in:
an extraction column or a mixer-decanter, based on silicon carbide or based on a fluoropolymer preferably as defined previously; or
an extraction column or a mixer-decanter, made of steel, preferably made of carbon steel, said extraction column or said mixer-decanter comprising an inner surface, said inner surface liable to be in contact with the lithium salt of bis(fluorosulfonyl)imide being covered with a polymeric coating preferably as defined previously or with a silicon carbide coating.

Preferably, the liquid-liquid extraction step b) is performed in:
an extraction column or a mixer-decanter based on a fluoropolymer, for instance PVDF (polyvinylidene fluoride), or PFAs (copolymers of C₂F₄ and of perfluorinated vinyl ether); or
an extraction column or a mixer-decanter, made of steel, preferably made of carbon steel, said extraction column or said mixer-decanter comprising an inner surface, said inner surface liable to be in contact with the lithium salt of bis(fluorosulfonyl)imide being covered with a polymeric coating preferably as defined previously.

The extraction column may comprise:
at least one packing, for instance random packing and/or structured packing. This packing may be Raschig rings, Pall rings, Saddle rings, Berl saddles, Intalox saddles, or beads; and/or
trays, for instance perforated trays, fixed valve trays, movable valve trays, bubble trays or combinations thereof;

and/or
devices for atomizing one phase in another, for instance nozzles;
   said packing(s), tray(s) or atomization device(s) preferably being made of a polymeric material, the polymeric material possibly comprising at least one polymer chosen from polyolefins, for instance polyethylene, fluoropolymers, for instance PVDF (polyvinylidene fluoride), PTFE (polytetrafluoroethylene), PFAs (copolymers of C₂F₄ and of perfluorinated vinyl ether), FEPs (copolymers of tetrafluoroethylene and of perfluoropropene, for instance the copolymer of C₂F₄ and of C₃F₆), ETFE (copolymer of tetrafluoroethylene and of ethylene), and FKM (copolymer of hexafluoropropylene and of difluoroethylene).

The extraction column may also comprise chicanes integrally fastened to the side walls of said column. The chicanes advantageously make it possible to limit the phenomenon of axial mixing.

The height and/or diameter of the extraction column typically depend(s) on the nature of the liquids to be separated.

The extraction column may be a static or stirred column. Preferably, the extraction column is stirred, preferentially mechanically. It comprises, for example, one or more stirring heads attached to an axial rotating shaft. Among the stirring heads, examples that may be mentioned include turbomixers (for example Rushton straight-blade turbomixers or curved-blade turbomixers), impellers (for example profiled-blade impellers), disks, and mixtures thereof. Stirring advantageously allows the formation of fine droplets to disperse one liquid phase in the other, and thus to increase the interfacial area of exchange. Preferably, the stirring speed is chosen so as to maximize the interfacial area of exchange.

Preferably, the stirring head(s) are made of a steel material, preferably of carbon steel, comprising an outer surface, said outer surface liable to be in contact with the lithium salt of bis(fluorosulfonyl)imide being covered with a polymeric coating preferably as defined previously, or with a silicon carbide coating.

Step b) of the process according to the invention advantageously makes it possible to recover an organic phase, saturated with water, containing the LiFSI (it is a solution of LiFSI in the at least organic solvent S2, said solution being saturated with water).

The solvent S2 for extraction of the LiFSI salt dissolved in deionized water is advantageously:
a good solvent for the LiFSI salt, i.e. the LiFSI may have a solubility of greater than or equal to 10% by weight relative to the total weight of the sum of LiFSI plus solvent; and/or
sparingly soluble in water, i.e. it has a solubility of less than or equal to 1% by weight relative to the total weight of the sum of solvent plus water.

According to one embodiment, the organic solvent S2 is chosen from the group constituted of esters, nitriles, ethers, chlorinated solvents and aromatic solvents, and mixtures thereof. Preferably, the solvent S2 is chosen from ethers and esters, and mixtures thereof. For example, mention may be made of diethyl carbonate, dimethyl carbonate, ethyl methyl carbonate, methyl t-butyl ether, cyclopentyl methyl ether, ethyl acetate, propyl acetate, methyl acetate, butyl acetate, methyl propionate, dichloromethane, tetrahydrofuran, diethyl ether, and mixtures thereof. Preferably, the solvent S2 is chosen from methyl t-butyl ether, cyclopentyl methyl ether, ethyl acetate, propyl acetate and butyl acetate, and mixtures thereof, said organic solvent S2 advantageously being butyl acetate.

According to the invention, step b) of the process may be repeated at least once, preferably repeated from 1 to 10 times, preferentially from 1 to 4 times. When step b) is repeated, it may be performed in several mixer-decanters in series. In the event of multiple extractions (repetition of step b)), the extracted organic phases are pooled to form a single organic solution.

Step b) may be performed continuously or batchwise, preferably continuously.

According to one embodiment, step b) of the purification process according to the invention comprises the addition of at least one organic solvent S2 to the aqueous solution of LiFSI, to allow the dissolution of said salt, and the extraction of said salt into the organic phase.

In the particular case of a batchwise process, and during the repetition of step b), the mass amount of organic solvent(s) S2 used may range between 1/6 and 1 times the mass of the aqueous phase. Preferably, the organic solvent(s) S2/water mass ratio, during an extraction step b), ranges from 1/6 to 1/1, the number of extractions ranging in particular from 2 to 10.

According to one embodiment, the mass content of LiFSI in solution in the organic phase obtained on conclusion of step b) is between 5% and 35%, preferably between 10% and 25% by mass, relative to the total mass of the solution.

### Step c)

Step c) may comprise:
a step c-1) of preconcentration of the solution obtained in the preceding step; and
a step c-2) of concentration of the solution obtained in step c-1).

### Step c-1)

Step c-1) advantageously makes it possible to obtain a solution of LiFSI in the at least organic solvent S2 comprising a mass content of LiFSI of between 20% and 60% and preferably between 30% and 50% by mass relative to the total mass of the solution.

The preconcentration step c-1) may be performed:
at a temperature ranging from 25° C. to 60° C., preferably from 25° C. to 50° C., and/or
under reduced pressure, for example at a pressure below 50 mbar abs, in particular at a pressure below 30 mbar abs.

Step c-1) may be performed in equipment chosen from an evaporator or an exchanger.

According to one embodiment, the preconcentration step c-1) is performed in:
an exchanger or an evaporator, based on silicon carbide or based on a fluoropolymer preferably as defined previously; or
an exchanger or an evaporator, made of steel, preferably made of carbon steel, said exchanger or evaporator comprising an inner surface, said inner surface liable to be in contact with the lithium salt of bis(fluorosulfonyl)imide being covered with a polymeric coating preferably as defined previously or with a silicon carbide coating.

Preferably, step c-1) is performed in:
an exchanger or evaporator, based on silicon carbide; or
an exchanger or evaporator, made of steel, preferably made of carbon steel, said exchanger or evaporator comprising an inner surface, said inner surface liable to be in contact with the lithium salt of bis(fluorosulfonyl)imide being covered with a silicon carbide coating.

Step c-1) advantageously makes it possible to obtain a solution of LiFSI in the organic solvents S2 comprising a mass content of water of less than or equal to 20 000 ppm.

### Step c-2)

Step c-2) may be performed in equipment chosen from an evaporator, for instance a thin-film evaporator (and preferentially a short-path thin-film evaporator), or an exchanger.

Preferably, step c-2) is performed in a short-path thin-film evaporator.

Step c-2) may be performed in:
an exchanger or an evaporator, based on silicon carbide or based on a fluoropolymer preferably as defined previously; or
an exchanger or evaporator, made of steel, preferably made of carbon steel, said exchanger or evaporator comprising an inner surface, said inner surface liable to be in contact with the lithium salt of bis(fluorosulfonyl)imide being covered with a polymeric coating preferably as defined previously or with a silicon carbide coating.

According to a preferred embodiment, the purification process according to the invention comprises a step c-2) of concentration of the lithium salt of bis(fluorosulfonyl)imide by evaporation of said at least one organic solvent S2, in a short-path thin-film evaporator, preferably under the following conditions:
temperature of between 30° C. and 100° C.;
pressure of between 10⁻³ mbar abs and 5 mbar abs;
residence time of less than or equal to 15 minutes.

According to one embodiment, the concentration step c-2) is performed at a pressure of between 10⁻² mbar abs and 5 mbar abs, preferably between 5×10⁻² mbar abs and 2 mbar abs, preferentially between 5×10⁻¹ and 2 mbar abs, even more preferentially between 0.1 and 1 mbar abs and in particular between 0.1 and 0.6 mbar abs.

According to one embodiment, step c-2) is performed at a temperature of between 30° C. and 95° C., preferably between 40° C. and 90° C., preferentially between 40° C. and 85° C., and in particular between 50° C. and 80° C.

According to one embodiment, step c-2) is performed with a residence time of less than or equal to 10 minutes, preferentially less than 5 minutes, preferably less than or equal to 3 minutes.

In the context of the invention, and unless otherwise mentioned, the term “residence time” means the time which elapses between the entry of the solution of lithium bis(fluorosulfonyl)imide salt (in particular obtained on conclusion of the abovementioned step b)) into the evaporator and the exit of the first drop of the solution.

According to a preferred embodiment, the temperature of the condenser of the thin-film short-path evaporator is between −55° C. and 10° C., preferably between−50° C. and 5° C., more preferentially between −45° C. and −10° C., and advantageously between −40° C. and −15° C.

The short-path thin-film evaporators according to the invention are also known as “wiped-film short-path” (WFSP) evaporators. They are typically referred to as such since the vapors generated during the evaporation cover a short path (travel a short distance) before being condensed in the condenser.

Among the short-path thin-film evaporators, mention may notably be made of the evaporators sold by the companies Buss SMS Ganzler ex Luwa AG, UIC GmbH or VTA Process.

Typically, the short-path thin-film evaporators may comprise a condenser for the solvent vapors placed inside the machine itself (in particular at the center of the machine), unlike other types of thin-film evaporator (which are not short-path evaporators) in which the condenser is outside the machine.

In this type of machine, the formation of a thin film, of product to be distilled, on the hot inner wall of the evaporator may typically be ensured by continuous spreading over the evaporation surface with the aid of mechanical means specified below.

The evaporator may notably be equipped, at its center, with an axial rotor on which are mounted the mechanical means that allow the formation of the film on the wall. They may be rotors equipped with fixed vanes, lobed rotors with three or four vanes made of flexible or rigid materials, distributed over the entire height of the rotor, or rotors equipped with mobile vanes, paddles, brushes, doctor blades or guided scrapers. In this case, the rotor may be constituted by a succession of pivot-articulated paddles mounted on a shaft or axle by means of radial supports. Other rotors may be equipped with mobile rollers mounted on secondary axles and said rollers are held tight against the wall by centrifugation. The spin speed of the rotor, which depends on the size of the machine, may be readily determined by a person skilled in the art.

According to one embodiment, the solution of LiFSI salt is introduced into the short-path thin-film evaporator with a flow rate of between 700 g/h and 1200 g/h, preferably between 900 g/h and 1100 g/h for an evaporation surface of 0.04 m².

According to the invention, on conclusion of the abovementioned step c), the LiFSI may be obtained in solid form, and in particular in crystalline form, or in the form of a concentrated solution, the concentrated solution comprising less than 35% by weight of residual solvent, preferably less than 30% by weight.

### Step d)

According to one embodiment, the process according to the invention also comprises a step d) of crystallization of the lithium bis(fluorosulfonyl)imide salt obtained on conclusion of the abovementioned step c).

Preferably, during step d), the LiFSI is crystallized under cold conditions, notably at a temperature of less than or equal to 25° C.

Preferably, step d) of crystallization of the LiFSI is performed in an organic solvent S3 (crystallization solvent) chosen from chlorinated solvents, for instance dichloromethane, from alkanes, for instance pentane, hexane, cyclohexane or heptane, and from aromatic solvents, for instance toluene, in particular at a temperature of less than or equal to 25° C. Preferably, the LiFSI crystallized on conclusion of step d) is recovered by filtration.

### Preparation of LiFSI

The initial solution of lithium bis(fluorosulfonyl)imide salt in at least one solvent S1 may come from any synthesis of the lithium bis(fluorosulfonyl)imide salt, in particular comprising the following steps
i) synthesis of bis(chlorosulfonyl)imide;
ii) fluorination of bis(chlorosulfonyl)imide to bis(fluorosulfonyl)imide;
iii) preparation of an alkali metal or alkaline-earth metal salt of bis(fluorosulfonyl)imide by neutralization of the bis(fluorosulfonyl)imide;
iv) optional cation exchange to obtain the lithium salt of bis(fluorosulfonyl)imide.

On conclusion of these steps, the lithium salt of bis(fluorosulfonyl)imide is preferably obtained in solution in an organic solvent (corresponding in particular to the solvent S1), at a mass concentration of between 5% and 50% by mass relative to the total mass of the solution.

Such a process is described, for example, in WO 2015/158979.

### Step iv)

Step iv) corresponds to a cation-exchange reaction, subsequent to step (iii), comprising the reaction between the alkaline-earth metal salt of bis(fluorosulfonyl)imide and a lithium salt, to obtain the lithium salt of bis(fluorosulfonyl)imide.

Step iv) is in particular a cation-exchange reaction for converting a compound of the abovementioned formula (I) F—(SO₂)—NM—(SO₂)—F (I), M representing a monovalent cation of an alkali metal or alkaline-earth metal, into the lithium salt of bis(fluorosulfonyl)imide.

Preferably, the lithium salt is chosen from LiF, LiCl, Li₂CO₃, LiOH, LiNO₃, LiBF₄ and mixtures thereof.

The lithium salt may be dissolved in a polar organic solvent chosen from the following families: alcohols, nitriles and carbonates. By way of example, mention may notably made of methanol, ethanol, acetonitrile, dimethyl carbonate, ethyl methyl carbonate, and mixtures thereof.

The mole ratio of the compound of formula (I) relative to the lithium salt may vary: it may be at least equal to 1 and less than 5. Preferably, the mole ratio of compound of formula (I/lithium salt is between 1.2 and 2.

The reaction medium may be left to stir for between 1 to 24 hours, and/or at a temperature of between, for example, 0° C. and 50° C.

At the end of the reaction, the reaction medium may be filtered and then optionally concentrated. The concentration step may optionally be performed with a thin-film evaporator, an atomizer, an evaporator or any other device enabling solvent evaporation.

The filtration may be performed using a filter or a centrifugal separator.

Step iv) may be performed in a reactor based on silicon carbide or based on a fluoropolymer preferably as defined previously; or in a steel reactor comprising an inner surface, said inner surface liable to be in contact with the lithium salt of bis(fluorosulfonyl)imide being covered with a polymeric coating or with a silicon carbide coating.

The polymeric coating may be a coating comprising at least one of the following polymers: polyolefins, for instance polyethylene, fluoropolymers, for instance PVDF (polyvinylidene fluoride), PTFE (polytetrafluoroethylene), PFAs (copolymers of C₂F₄ and of perfluorinated vinyl ether), FEPs (copolymers of tetrafluoroethylene and of perfluoropropene, for instance the copolymer of C₂F₄ and of C₃F₆), ETFE (copolymer of tetrafluoroethylene and of ethylene), and FKM (copolymer of hexafluoropropylene and of difluoroethylene). Preferably, the polymeric coating comprises at least one fluoropolymer, and in particular PFA, PTFE or PVDF.

According to one embodiment, the reactor of step iv) is a stirred reactor equipped with stirring head(s).

Among the stirring heads, examples that may be mentioned include turbomixers (for example Rushton straight-blade turbomixers or curved-blade turbomixers), helical strips, impellers (for example profiled-blade impellers), anchors, and combinations thereof.

The stirring head(s) may be attached to a central stirring shaft, and may be of identical or different nature. The stirring shaft may be driven by a motor, which is advantageously outside the reactor.

The design and size of the stirring heads may be chosen by a person skilled in the art as a function of the type of mixing to be performed (mixing of liquids, mixing of liquid and solid, mixing of liquid and gas, mixing of liquid, gas and solid) and of the desired mixing performance. In particular, the stirring head is chosen from the stirring heads that are the best suited for ensuring good homogeneity of the reaction medium.

Preferably, the stirring head(s) are made of a steel material, preferably of carbon steel, comprising an outer surface, said outer surface liable to be in contact with the lithium salt of bis(fluorosulfonyl)imide being covered with a polymeric coating preferably as defined previously, or with a silicon carbide coating.

### Purification Process

According to a preferred embodiment, the purification process according to the invention comprises the following steps:

a) liquid-liquid extraction of the lithium salt of bis(fluorosulfonyl)imide with deionized water, and recovery of an aqueous solution of said lithium salt of bis(fluorosulfonyl)imide;

a′) concentration of said aqueous solution of said salt;

b) liquid-liquid extraction of the lithium salt of bis(fluorosulfonyl)imide from said aqueous solution with at least one organic solvent S2;

c) concentration of the lithium salt of bis(fluorosulfonyl)imide by evaporation of said organic solvent S2, said step c) comprising:
a step c-1) of preconcentration of the solution obtained in the preceding step; and
a step c-2) of concentration of the solution obtained in step c-1);

d) optional crystallization of the lithium salt of bis(fluorosulfonyl)imide;

at least one of the steps a), a′), b) or c-1), preferably all the steps a), a′), b) and c-1), being performed in:
equipment based on silicon carbide or based on a fluoropolymer; or
equipment made of steel, preferably made of carbon steel, comprising an inner surface, said inner surface liable to be in contact with the lithium salt of bis(fluorosulfonyl)imide being covered with a polymeric coating preferably as defined previously or with a silicon carbide coating.

The purification process according to the invention advantageously leads to an LiFSI of high purity, and preferentially to an LiFSI of high purity having a reduced or even zero content of metal ions. The term “metal ions” in particular means ions derived from transition metals (for instance Cr, Mn, Fe, Ni, Cu), ions derived from post-transition metals (for instance Al, Zn and Pb), ions derived from alkali metals (for instance Na), ions derived from alkaline-earth metals (for instance Mg and Ca), and ions derived from silicon.

Thus, the process according to the invention advantageously leads to an LiFSI with a reduced or even zero content of ions derived from the following metals: Cr, Mn, Fe, Ni, Cu, Al, Zn, Mo, Co, Pb, Na, Si, Mg, Ca.

In particular, the process according to the invention advantageously leads to a composition comprising at least 99.9% by weight of LiFSI, preferably at least 99.95% by weight, preferentially at least 99.99% by weight of LiFSI, and said LiFSI optionally comprising at least one of the following impurities in the amounts indicated: 0≤H₂O≤100 ppm, 0≤Cl⁻≤100 ppm, 0≤SO₄²⁻≤100 ppm, 0≤F⁻≤200 ppm, 0≤FSO₃Li≤20 ppm, 0≤FSO₂NH₂≤20 ppm, 0≤K≤100 ppm, 0—Na≤10 ppm, 0≤Si≤40 ppm, 0≤Mg10 ppm, 0≤Fe≤10 ppm, 0≤Ca≤10 ppm, 0≤Pb≤10 ppm, 0Cu≤10 ppm, 0≤Cr≤10 ppm, 0≤Ni≤10 ppm, 0≤Al ≤10 ppm, 0≤Zn≤10 ppm, 0≤Mn10 ppm, and/or 0≤Co≤10 ppm.

In the context of the invention, the term “ppm” means ppm on a weight basis.

All the embodiments described above may be combined with each other. In particular, each embodiment of any step of the process of the invention may be combined with another particular embodiment.

In the context of the invention, the term “between x and y” or “ranging from x to y” means a range in which the limits x and y are included. For example, the temperature “between 30 and 100° C.” notably includes the values 30° C. and 100° C.

The examples that follow illustrate the invention without, however, limiting it.

Sampling for theQquantification of Li and Na:
The sample of the lithium salt of bis(fluorosulfonyl)imide is dissolved in ultra-pure water. Two dilutions were used: 1 g/l for the determination of Na and K and 0.1 g/l for the analysis of lithium.

### Panoramic Qualitative Analysis:

The ICP-AES (inductively-coupled plasma spectrometry) conditions applied for the “panoramic” semiquantitative analysis of the elements in trace amount are:
Output power of the plasma source: 1150 W;

Flow rate of the nebulization gas: 0.7 L/min;

Cooling rate=16 L/min;

Torch height: 12 mm;

Pump speed: 50 rpm;

Spectral bandwidth: 7 pm to 200 nm, 3.5 nm per pixel;

Wavelength range: 167 nm to 847 nm.

The ICP-AES quantification method for measuring Li, Na, K used five calibration points. The ICP-AES data are obtained on an ICAP 6500 spectrometer (Thermo Electronics). For the analysis of the elements in trace amount Ag, Al, As, Ba, Si, Cd, Co, Cr, Cu, Ni, Pb, Sb, Se, Sn, Sr, Ti, Zn, the semiquantitative method is based on two calibration points.

For the two methods, calibration is performed by addition of standards to the sample itself so as to minimize the matrix effects.

ICP-AES is preferred to cationic chromatography in aqueous solution for the measurement of the elements Li, Na and K.

The conditions for analysis of the anions in ion chromatography (IC) are as follows:
Thermo ICS 5000 DUAL machine;
AS16-HC column;
Flow rate 1 ml/min;
Eluent isocratic KOH at 20 mmol/l;
Conductimetric detection;
ASRS 4 mm suppressor with 50 mA of imposed current;
Injection of 25 μl of LiFSI solutions at 5 g/l and 10 g/l depending on the sensitivity required for the anionic species present;
Calibration of each anionic species with five synthetic solutions ranging from 0.1 mg/l up to 25 mg/l.

The following species are detected according to the analytical methods indicated below:

| Species | Analysis method |
|---|---|
| SO₄²⁻ | IC |
| Cl⁻ | IC |
| Na+ | ICP |
| K+ | ICP |

### EXAMPLE 1 (COMPARATIVE)

### Purification of a Solution of LiFSI in Butyl Acetate with a Solids Content of 42.8% Containing 670 ppm of Chloride, 23 ppm of Sulfate, 300 ppm of Potassium and No Detected Sodium

3153 g of the above solution are submitted to extraction four times in a glass separating funnel with, successively, 1570 g, 1045 g, 792 g and 792 g of water. The aqueous phases are pooled and concentrated under vacuum in a glass reactor to a solids content of 41.5%. This aqueous solution is then subjected to extraction four times in a glass separating funnel with, successively, 1342 g, 1342 g, 672 g and 672 g of butyl acetate. The organic phases are then pooled and concentrated under vacuum in a glass reactor to a solids content of 41%. This solution is again concentrated using a short-path glass evaporator at a reduced pressure of 0.6 mbar absolute with a heating temperature of 60° C. and a condenser set at −41° C. The LiFSI precipitates and is then recovered under an anhydrous atmosphere by filtration. The solid is dried under vacuum at room temperature. Analysis by ion chromatography of the LiFSI obtained shows 8 ppm of chlorides, absence of detection of sulfate, 12 ppm of potassium and 55 ppm of sodium.

### EXAMPLE 2 (According to the Invention)

### Purification of a Solution of LiFSI in Butyl Acetate with a Solids Content of 41.8% Containing 690 ppm of Chloride, 25 ppm of Sulfate, 315 ppm of Potassium and No Detected Sodium

3255 g of the above solution are submitted to extraction four times in a PTFE separating funnel with, successively, 1620 g, 1079 g, 818 g and 818 g of water. The aqueous phases are pooled and concentrated under vacuum in a PFA-lined stainless-steel reactor to a solids content of 41%. This aqueous solution is then subjected to extraction four times in a PTFE separating funnel with, successively, 1385 g, 1385 g, 694 g and 694 g of butyl acetate. The organic phases are then pooled and concentrated under vacuum in a PFA-lined stainless-steel reactor to a solids content of 42%. This solution is again concentrated using a short-path silicon carbide evaporator at a reduced pressure of 0.6 mbar absolute with a heating temperature of 60° C. and a condenser set at −40° C. The LiFSI precipitates and is then recovered under an anhydrous atmosphere by filtration. The solid is dried under vacuum at room temperature. Analysis by ion chromatography of the LiFSI obtained shows 10 ppm of chlorides, absence of detection of sulfate, 10 ppm of potassium and absence of detection of sodium.

1. A process for purifying a lithium bis(fluorosulfonyl)imide salt in solution in at least one solvent S1, said process comprising at least one purification step performed in:
equipment based on silicon carbide or a fluoropolymer; or
equipment made of steel, comprising an inner surface, said inner surface liable to be in contact with the lithium salt of bis(fluorosulfonyl)imide being covered with a polymeric coating or with a silicon carbide coating.

2. The process as claimed in claim 1, in which the solvent S1 is an organic solvent.

3. The process as claimed in claim 1, in which the purification step is a step in which the lithium salt of bis(fluorosulfonyl)imide is in contact with water.

4. The process as claimed in claim 1, comprising the following steps:
a) liquid-liquid extraction of the lithium salt of bis(fluorosulfonyl)imide with deionized water, and recovery of an aqueous solution of said lithium salt of bis(fluorosulfonyl)imide;
a′) optional concentration of said aqueous solution of said salt;
b) liquid-liquid extraction of the lithium salt of bis(fluorosulfonyl)imide from said aqueous solution with at least one organic solvent S2;
c) concentration of the lithium salt of bis(fluorosulfonyl)imide by evaporation of said organic solvent S2;
d) optional crystallization of the lithium salt of bis(fluorosulfonyl)imide;
at least one of the steps a), a′), b) or c) being performed in:
equipment based on silicon carbide or based on a fluoropolymer; or
equipment made of steel comprising an inner surface, said inner surface liable to be in contact with the lithium salt of bis(fluorosulfonyl)imide being covered with a polymeric coating or with a silicon carbide coating.

5. The process as claimed in claim 1, in which the polymeric coating comprises at least one of the following polymers: polyolefins and fluoropolymers.

6. The process as claimed in claim 1, in which the fluoropolymer is chosen from PVDF (polyvinylidene fluoride), PTFE (polytetrafluoroethylene), PFAs (copolymers of C₂F₄ and of perfluorinated vinyl ether) and ETFE (copolymer of tetrafluoroethylene and of ethylene).

7. The process as claimed in claim 4, in which the liquid-liquid extraction step a) is performed in:
an extraction column or a mixer-decanter, based on silicon carbide or based on a fluoropolymer; or
an extraction column or a mixer-decanter, made of steel, said extraction column or said mixer-decanter comprising an inner surface, said inner surface liable to be in contact with the lithium salt of bis(fluorosulfonyl)imide being covered with a polymeric coating with a silicon carbide coating.

8. The process as claimed in claim 4, in which step a) is repeated at least once.

9. The process as claimed in claim 4, comprising a concentration step a′), which is performed:
under reduced pressure; and/or
at a temperature of between 25° C. and 60° C.

10. The process as claimed in claim 4, in which the concentration step a′) is performed in:
an exchanger or an evaporator, based on silicon carbide or based on a fluoropolymer; or
an exchanger or evaporator, mace of steel, said exchanger or evaporator comprising an inner surface, said inner surface liable to be in contact with the lithium salt of bis(fluorosulfonyl)imide being covered with a polymeric coating, or with a silicon carbide coating.

11. The process as claimed in claim 4, in which the liquid-liquid extraction step b) is performed in:
an extraction column or a mixer-decanter, based on silicon carbide or based on a fluoropolymer; or
an extraction column or a mixer-decanter, made of steel, said extraction column or said mixer-decanter comprising an inner surface, said inner surface liable to be in contact with the lithium salt of bis(fluorosulfonyl)imide being covered with a polymeric coating or with a silicon carbide coating.

12. The process as claimed in claim 4, in which the organic solvent S2 is chosen from the group constituted of esters, nitriles, ethers, chlorinated solvents, aromatic solvents, and mixtures thereof.

13. The process as claimed in claim 4, in which step c) comprises:
a step c-1) of preconcentration of the solution obtained in the preceding step; and
a step c-2) of concentration of the solution obtained in step c-1).

14. The process as claimed in claim 13, in which the preconcentration step c-1) is performed:
at a temperature ranging from 25° C. to 60° C. and/or
under reduced pressure.

15. The process as claimed in claim 13, in which the preconcentration step c-1) is performed in:
an exchanger or an evaporator, based on silicon carbide or based on a fluoropolymer; or
an exchanger or an evaporator, made of steel, said exchanger or evaporator comprising an inner surface, said inner surface liable to be in contact with the lithium salt of bis(fluorosulfonyl)imide being covered with a polymeric coating or with a silicon carbide coating.

16. The process as claimed in claim 12, in which step c-2) of concentration of the lithium salt of bis(fluorosulfonyl)imide by evaporation of said at least one organic solvent S2 is performed in a short-path thin-film evaporator, under the following conditions:
temperature of between 30° C. and 100° C.;
pressure of between 10⁻³ mbar abs and 5 mbar abs;
residence time of less than or equal to 15 minutes.

17. The process as claimed in claim 4, comprising step d) of crystallization at a temperature of less than or equal to 25° C.

18. The process as claimed in claim 1, in which the lithium salt of bis(fluorosulfonyl)imide comes from a synthesis comprising the following steps:
i) synthesis of bis(chlorosulfonyl)imide.
ii) fluorination of bis(chlorosulfonyl)imide to bis(fluorosulfonyl)imide;
iii) preparation of an alkali metal or alkaline-earth metal salt of bis(fluorosulfonyl)imide by neutralization of the bis(fluorosulfonyl)imide;
iv) optional cation exchange to obtain the lithium salt of bis(fluorosulfonyl)imide.
